(19) United States
(12) Patent Application Publication
(10) Pub. No.: US 2007/0110066 A1
(43) Pub. Date: May 17, 2007

(54) System and method for searching target devices within the same subnet

(75) Inventor: Chih-Wei Chen, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/394,074

(22) Filed: Mar. 29, 2006

(30) Foreign Application Priority Data
Nov. 15, 2005 (TW) 94140021

(51) Int. Cl. H04L 12/56

(52) U.S. Cl. 370/392; 370/401

(57) ABSTRACT

A system and method for searching target devices within the same subnet for connecting target devices to a master control device in a network. A first query packet is broadcasted by the master control device after being activated via the network to query the IP addresses of all target devices on the network. The master control device stores the IP addresses replied by the target devices in response to the first query packet while the target devices receiving the first query packet store the IP address of the master control device included in the first query packet.

### FIELD OF THE INVENTION

The present invention relates to a system and method for searching target devices within the same subnet, and more particularly, to a system and method that enables a master control device to automatically and quickly search target devices within the same subnet.

### BACKGROUND OF THE INVENTION

The current method for searching target devices within the same subnet normally is by executing a “ping” instruction one by one from the beginning IP (Internet Protocol) address within the subnet to the ending IP address thereof. “Ping” is a very simple and easy to use instruction for diagnosing the on-line state and on-line quality of the network. The “ping” instruction checks the on-line state of the network via the echo function of the ICMP (Internet Control Message Protocol). By sending a small packet to the specific IP address in the network and then waiting for the response packet, if the network status is fine and the target computer functions normally, then the send-end will receive a complete response packet. When the IP address responses with a target device, the master control device records the IP address into the target device list for subsequent management and use. However, using each “ping” instruction requires waiting for the response of the IP address, if the IP address is an empty IP address (i.e., such IP address is not used by any device), then there is no response from the IP address. Therefore, a timeout must be set to avoid unnecessary wait. The period of the timeout greatly affects the searching efficiency. If the timeout period is too long, the searching time for the whole subset will be significant; if the timeout period is too short, the IP addresses of some target devices will not be able to response before the timeout due to the heavy network traffic, so as to cause the master control device consider that there are no target devices associated with those IP addresses. On the other hand, the master control device cannot know if the target device shutdowns. Also, the master control device cannot know the target device to the IP address newly added after the master control device searching the IP address.

Therefore, the master control device typically has a refresh function, activated by user or automatically activated by the system. There are two implementations of the refresh function, the first is to query again the IP addresses in accordance with the target device list, so as to know if any target device is off-line (or removed); the second is to search one by one from the beginning IP address within the subnet to the ending IP address thereof, so as to know if there is any device that is newly added. However, the above two implementations still have defects, the prior cannot find target device that is newly added; the latter is time consuming.

In the same subnet, data can be transferred by broadcast. Searching target devices by broadcasting can greatly decrease the waiting time. However, broadcast consumes network bandwidth enormously due to the probability of packet collisions greatly increases. Once a collision is detected, two source nodes both send a jam signal to the whole subnet, at that time, all nodes in the subnet stop transferring and change to a wait state for the next chance to transfer, that causes network traffic jam.

Therefore, for network system of which transfer speed is important, how to quickly search for required target devices within the same subnet while preventing decreased transfer speed due to network traffic jam is a problem urgently needed to be solved.

### SUMMARY OF THE INVENTION

In light of the above drawbacks in the prior art, an objective of the present invention is to provide a system and method for searching target devices within the same subnet for automatically and quickly completing searching of target devices within the same subnet.

In accordance with the above and other objectives, the present invention proposes a system and method for searching target devices within the same subnet. The system for searching target devices within the same subnet enables target devices in the network to make a connection with a master control device. The system comprises a target device IP address recording section to store the IP address of the target device; a master control device initializing module to broadcast a first query packet to query the IP address of the target device when the master control device is activated; a master control device packet processing module to store the IP address of the target device obtained after querying into the target device IP address recording section; a master control device IP address recording section to store the IP address of the master control device; and a target device packet processing module to perform a corresponding process in accordance with the received packet, so as to store the IP address of the master control device included in the first query packet into the master control device IP address recording section.

The method for searching target devices within the same subnet of the present invention enables target devices in the network to make a connection with a master control device. The method comprises broadcasting a first query packet via the network by the master control device after it is activated to query the IP address of the target device; and storing the IP address replied by the target device in response to the first query packet in the master control device while storing the IP address of the master control device included in the first query packet in the target device receiving the first query packet.

By utilizing the system and method for searching target devices within the same subnet of the present invention, when searching target devices within the same subnet, there is no need to search the IP address one by one and search the next IP address only when the response of the current IP address is received. Meanwhile, there is no need to activate the refresh function by a user or by the system to know the off-line (or removed) and newly added target devices. In addition, the master control device only broadcasts once after activating, therefore, the problems of long timeout period, unable to know the off-line (or removed) and newly added target devices, and the network traffic jam are solved.

### BRIEF DESCRIPTION OF THE DRAWINGS

The present invention can be more fully understood by reading the following detailed description of the preferred embodiments, with reference made to the accompanying drawings, wherein:

FIG. 1 is a fundamental block diagram of the system for searching target devices within the same subnet of the prevent invention;

FIG. 2 is a flow chart of the method for searching target devices within the same subnet of the prevent invention with regard to the initialization of a master control device;

FIG. 3 is a flow chart of the method for searching target devices within the same subnet of the prevent invention with regard to processing of packets received from a network of a master control device; and

FIG. 4 is a flow chart of the method for searching target devices within the same subnet of the prevent invention with regard to searching a master control device by a target device.

### DETAILED DESCRIPTION OF THE PREFERRED EMBODIMENTS

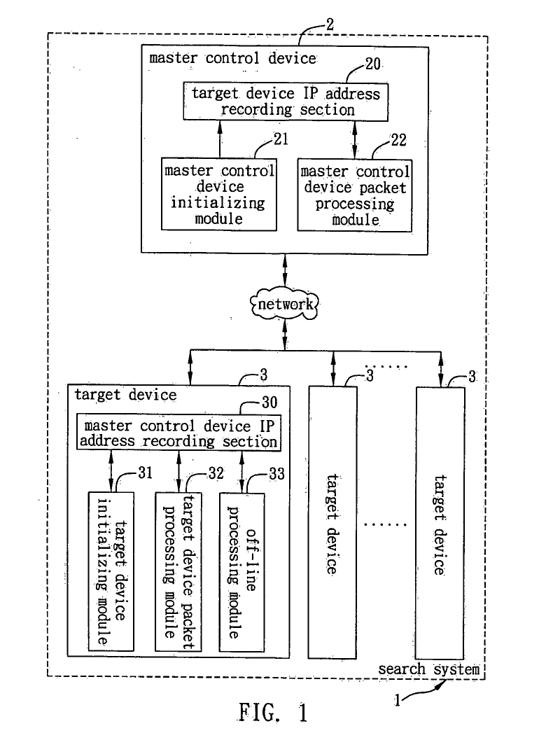

FIG. 1 is a fundamental block diagram of the system for searching target devices within the same subnet of the prevent invention. Referring to FIG. 1, the search system 1 comprises a master control device 2 and at least a target device 3 linked to the master control device 2 via a network. A network interface card (not shown) is installed in the master control device 2 and the target device 3 respectively, so as to link to the network. The target device 3 is a network equipment selected from the group consisting of a NAS (Network Attached Storage), a SAN (Storage Area Network), a hub, a switch, a personal computer, a server, a printer, a photocopier, a fax machine and the like. The master control device 2 at least comprises a target device IP address recording section 20, a master control device initializing module 21, and a master control device packet processing module 22. The target device 3 at least comprises a master control device IP address recording section 30, a target device initializing module 31, a target device packet processing module 32, and an off-line processing module 33.

The master control device 2 is used to manage the plurality of target devices 3. The target device IP address recording section 20 of the master control device 2 is used to store the IP addresses of the target devices 3. The master control device initializing module 21 is used to broadcast a first query packet via the network interface card when the master control device is activated, wherein the first query packet is used to query the IP address of a target device. The master control device packet processing module 22 is used to perform a corresponding process in accordance with the received packet, so as to store the IP address of the target device obtained after querying into the target device IP address recording section 20, or remove the IP address from the target device IP address recording section 20 in accordance with the received IP address of the target device to be removed (off-line) from the network.

The master control device IP address recording section 30 of the target device 3 is used to store the IP address of the master control device 2. The target device initializing module 31 sends a second query packet to the IP address of the master control device 2 stored in the master control device IP address recording section 30, wherein the second query packet is used to query if the device that uses the IP address is the master control device, so as to confirm if the IP address is still owned by the master control device 2, and when the IP address is not used by the master control device 2, then broadcasts a third query packet, wherein the third query packet is used to query the IP address of the master control device. The target device packet processing module 32 is used to perform a corresponding process in accordance with the received packet, it stores the IP address of the master control device included in the packet into the master control device IP address recording section 30, so as to let the target device packet processing module 32 access the data stored in the master control device 2 via the network in accordance with the IP address of the master control device stored in the master control device IP address recording section 30. The off-line processing module 33 is used to send a prompt packet to prompt the master control device to remove the IP address of the target device when the target device 3 shutdowns or is off-line.

Further, in another embodiment of the system for searching target devices within the same subnet of the prevent invention, the master control device 2 may further comprises an IP address transfer module to transfer the IP address information stored in the target device IP address recording section 20 of the master control device 2 to a conventional network management system (not shown) in a predetermined time for a network management engineer to conveniently manage the search system.

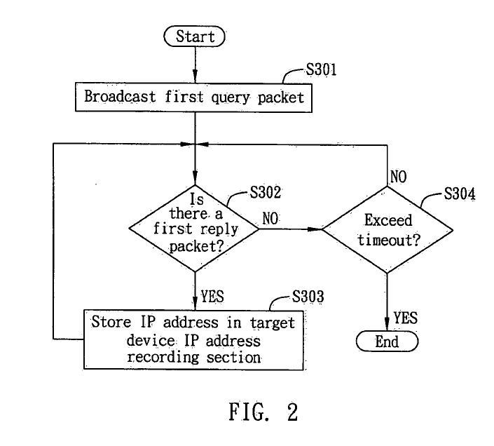

FIG. 2 is a flow chart of the method for searching target devices within the same subnet of the prevent invention with regard to the initialization of the master control device 2. Referring to FIG. 2, the search method is applied to the search system 1 shown in FIG. 1. After the master control device 2 is turned on, in step S301, a master control device initializing module 21 broadcasts a first query packet to query the IP addresses of the target devices. Then, go to step S302.

In step S302, the master control device 2 determines if a first reply packet is received, which would include the IP address of the target device that sends the reply packet. If yes, then go to step S303; if no, go to step S304.

In step S303, the received first reply packet is processed by the master control device packet processing module 22 in order to store the IP address of the target device included in the first reply packet into the target device IP address recording section 20, then return to step S302.

In step S304, the master control device determines if the timeout period is exceeded. If yes, the initialization of the master control device 2 of the search method of the present invention is finished; if no, then return to step S302, for continuously determining if any IP address is sent by any target device after broadcasting in order to record the IP addresses of the target devices in the network by the master control device packet processing module 22.

It should be noted that, in step S301, when the first query packet sent by the master control device 2 is received by a target device 3 in the network, the IP address of the master control device included in the first query packet is also stored into the master control device IP address recording section 30 by the target device 3 in order to access data stored in the master control device via the network in accordance with the IP address of the master control device stored in the master control device IP address recording section 30 by the target device packet processing module 32.

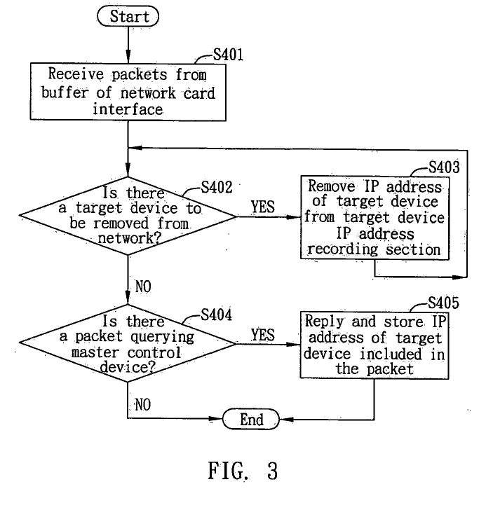

Moreover, FIG. 3 is a flow chart of the method for searching target devices within the same subnet of the prevent invention with regard to the processing of packets received by the master control device 2 via the network. Referring to FIG. 3, the search method is applied to the search system 1 shown in FIG. 1. After the master control device 2 is activated, in addition to the initialization shown in FIG. 2, it further performs the steps shown in FIG. 3. First, in step S401, a packet from a buffer of the network interface card is received by the master control device packet processing module 22 of the master control device 2, then go to step S402.

In step S402, the master control device determines if the received packet is a prompt packet, wherein the prompt packet is used to inform the master control device the IP address of a target device to be removed (off-line) from the network. If it is a prompt packet, then go to step S403; if not, then go to step S404.

In step S403, the master control device packet processing module 22 removes the IP address in accordance with the received IP address of the target device that is going to be removed (off-line) from the network, then back to step S402, for continuously determining if any other target device 3 needs to be removed from the network.

In step S404, the master control device determines if the received packet is a second query packet, wherein the second query packet is used to query if the device that receives the second query packet is the master control device. If it is a second query packet, then go to step S405; if not, end processing of packets received by the master control device 2 of the search method of the present invention.

In step S405, a second reply packet is sent by the master control device packet processing module 22, wherein the second reply packet is used to reply to the target device that sent the second query packet that this end is indeed the master control device. Meanwhile, the IP address of the target device 3 that sent the second query packet is stored into the target device IP address recording section 20 by the master control device 2. Then, the process returns to step S402, for the master control device 2 to continuously determine if any other target device needs to be removed from the network, or if there is a second query packet to query that if this end is the master control device.

Furthermore, in addition to the initialization and the processing of received packets from the network, the master control device 2 of the method for searching target devices within the same subnet further transfers the IP address information stored in the target device IP address recording section 20 to the conventional network management system in a predetermined time after initialization and packet processing for the network management engineer to conveniently manage the search system.

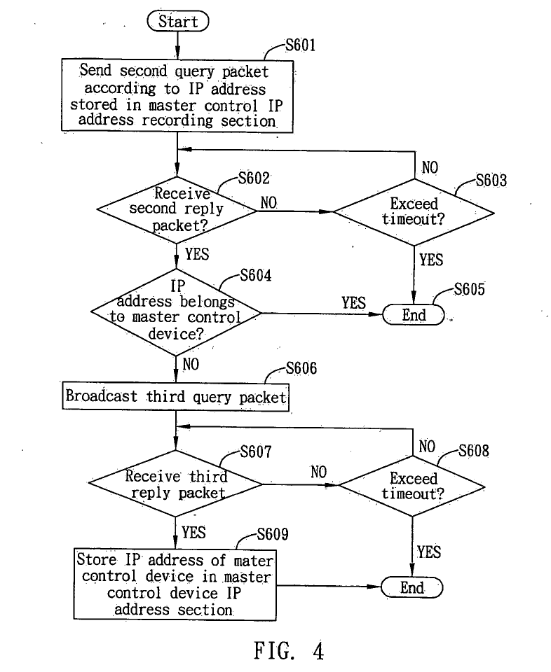

FIG. 4 is a flow chart of the method for searching target devices within the same subnet of the present invention with regard to searching the master control device 2 by the target device 3. Referring to FIG. 4, the search method is applied to the search system 1 shown in FIG. 1. After the target device 3 is activated, in step S601, a second query packet is sent to the IP address in accordance with the IP address of the master control device 2 stored in the master control device IP address recording section 30 by the target device initializing module 31 in order to query if the device that uses the IP address is the master control device, then go to step S602.

In step S602, the target device packet processing module 32 of the target device 3 determines if a second reply packet sent from the IP address is received. If yes, then go to step S604; if no, then go to step S603.

In step S603, the target device determines if the timeout is exceeded. If yes, ends the processing flow for searching the master control device 2 by the target device 3 of the search method of the present invention, wherein the reason why the master control device is not found in a predetermined time probably is because that the master control device had been removed (or off-line) from the network; if no, then back to step S602.

In step S604, the target device packet processing module 32 of the target device 3 determines if the received second reply packet indicates that the IP address is owned by the master control device. If yes, then ends the processing flow for searching the master control device 2 by the target device 3 of the search method of the present invention (i.e., the master control device 2 is found by the target device 3); if no, go to step S606.

In step S606, a third query packet is broadcasted by the target device initializing module 31 of the target device in order to query every device on the network about the IP address of the master control device via the network, then go to step S607.

In step S607, the target device packet processing module 32 of the target device 3 determines if a third reply packet is received. If yes, then go to step S609; if not, then go to step S608.

In step S608, the target device 3 determines if the timeout is exceeded. If yes, ends the processing flow for searching the master control device 2 by the target device 3 of the search method of the present invention, wherein the reason why the master control device is not found in a predetermined time probably is because that the master control device had been removed (or off-line) from the network; if no, then return to step S607.

In step S609, the received third reply packet is processed by the target device packet processing module 32 so as to store the IP address of the master control device 2 included in the third reply packet into the master control device IP address recording section 30 in order to access data stored by the master control device via the network in accordance with the IP address of the master control device stored in the master control device IP address recording section 30 by the target device packet processing module 32, then ends the processing flow for searching the master control device 2 by the target device 3 of the search method of the present invention.

It should be noted that, since the system and method for searching target devices within the same subnet of the prevent invention makes the master control device 2 to transfer query packet by broadcast at initialization to search the IP addresses of the target devices in the network, the target devices may obtain the IP address of the master control device 2 while replying the received query packet and stores the obtained IP address of the master control device 2 into the master control device IP address recording section 30, so as to quickly find out the master control device 2 and access the data stored in the master control device 2 via the network in accordance with the IP address of the master control device stored in the master control device IP address recording section 30 by the target device packet processing module 32. Additionally, after being removed (off-line) from the network, if the target device 3 needs to be linked to the network and to search the master control device 2, the IP address of the master control device stored in the master control device IP address recording section 30 is obtained by the target device packet processing module 32.

It is thus clear that, by utilizing the system and method for searching target devices within the same subnet of the present invention, when searching target devices within the same subnet, there is no need to search the IP address one by one and search the next IP address only when the response of the current IP address is received. Meanwhile, there is no need to activate the refresh function by a user or by the system to know the off-line (or removed) and newly added target devices. In addition, the master control device only broadcasts once after activating, therefore, the problems of long timeout period, unable to know the off-line (or removed) and newly added target devices, and the network traffic jam are solved.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system for searching target devices within a same subnet of a network, for connecting at least one target device with a master control device, the system comprising:
a target device IP address recording section provided in the master control device, for storing an IP address of the target device;
a master control device initializing module provided in the master control device, for broadcasting a first query packet for querying the IP address of the target device when the master control device is activated;
a master control device packet processing module provided in the master control device, for storing the IP address of the target device obtained after querying into the target device IP address recording section;
a master control device IP address recording section provided in the target device, for storing an IP address of the master control device; and
a target device packet processing module provided in the target device, for storing the IP address of the master control device included in the first query packet into the master control device IP address recording section when the target device packet processing module receives the first query packet.

2. The system of claim 1, further comprising an off-line processing module provided in the target device, for sending a prompt packet to the master control device when the target device is going to be disconnected from the network.

3. The system of claim 2, wherein after the master control device receives the prompt packet, the master control device packet processing module removes the IP address from the target device IP recording section in accordance with the IP address of the target device to be disconnected from the network.

4. The system of claim 1, further comprising a target device initializing module provided in the target device, for sending a second query packet via the network in accordance with the IP address of the master control device stored in the master control device IP address recording section when the target device is activated, so as to query if an IP address included in the second query packet is associated with the master control device, wherein if the IP address is not associated with the master control device after querying, then the target device initializing module broadcasts a third query packet to query the IP address of the master control device via the network.

5. The system of claim 1, wherein the target device is a network device selected from the group consisting of a NAS (Network Attached Storage), a SAN (Storage Area Network), a hub, a switch, a personal computer, a server, a printer, a photocopier and a fax machine.

6. A method for searching target devices within a same subnet, for connecting at least one target device with a master control device, the method comprising the steps of:
broadcasting a first query packet via the network by the master control device after it is activated to query an IP address of the target device; and
storing the IP address replied by the target device in response to the first query packet in the master control device while storing an IP address of the master control device included in the first query packet in the target device receiving the first query packet.

7. The method of claim 6, further comprising sending a prompt packet from the target device to the master control device when the target device is going to be disconnected from the network.

8. The method of claim 7, wherein the master control device removes the IP address of the target device that sends the prompt packet when the master control device receives the prompt packet.

9. The method of claim 6, further comprising after the target device is activated, the target device sending a second query packet to the IP address of the master control device stored in the target device, so as to query if an IP address included in the second query packet is associated with the master control device, wherein if the IP address is not associated with the master control device after querying, then the target device broadcasts a third query packet to query the IP address of the master control device via the network.

10. The method of claim 6, wherein the target device is a network device selected from the group consisting of a NAS (Network Attached Storage), a SAN (Storage Area Network), a hub, a switch, a personal computer, a server, a printer, a photocopier and a fax machine.
